(19) United States
(12) Patent Application Publication
(10) Pub. No.: US 2011/0238196 A1
(43) Pub. Date: Sep. 29, 2011

(54) METHOD FOR SIMULATING ELECTROMAGNETIC FIELD, ELECTROMAGNETIC FIELD SIMULATION APPARATUS AND METHOD FOR MANUFACTURING SEMICONDUCTOR DEVICE

(76) Inventors: Masanori Takahashi, Kanagawa-ken (JP); Satoshi Tanaka, Kanagawa-ken (JP)

(21) Appl. No.: 13/038,901

(22) Filed: Mar. 2, 2011

(30) Foreign Application Priority Data
Mar. 24, 2010 (JP) 2010-68450

(51) Int. Cl. G06F 17/50; G06F 17/11

(52) U.S. Cl. 700/103; 703/2

(57) ABSTRACT

According to one embodiment, a method is disclosed for simulating an electromagnetic field. The method can set a first mesh on a calculation region provided based on a medium through which an electromagnetic wave propagates. The method can calculate an electromagnetic field distribution on the first mesh by a frequency region solution based on characteristic values of the medium allocated on the first mesh. The method can set a second mesh on the calculation region. The method can allocate the electromagnetic field distribution obtained by the frequency region solution to the second mesh. In addition, the method can update the electromagnetic field distribution allocated to the second mesh in a predetermined time unit by a time region solution.

### CROSS-REFERENCE TO RELATED APPLICATIONS

This application is based upon and claims the benefit of priority from the prior Japanese Patent Application No. 2010-068450, filed on Mar. 24, 2010; the entire contents of which are incorporated herein by reference.

### FIELD

Embodiments described herein relate generally to a method for simulating an electromagnetic field, an electromagnetic field simulation apparatus and a method for manufacturing a semiconductor device.

### BACKGROUND

In recent years, simulation methods for solving precisely a propagation state of the electromagnetic wave in accordance with Maxwell equation have been utilized in a wide range of areas with improvement of computing technology and hardware performance (for example, Japanese Patent No. 3993557).

One of these simulation methods is a method of defining a mesh on a calculation region to an object (object medium) and working out the propagation state of the electromagnetic wave on the mesh. It is necessary to define a mesh with fineness exceeding a certain level for expressing precisely the object medium and maintaining the calculation precision. On the other hand, recently analysis objects have been complex, and thus cost and time necessary for calculation have increased dramatically.

### BRIEF DESCRIPTION OF THE DRAWINGS

FIG. 1 is a flow chart showing a method for simulating an electromagnetic field of an embodiment;

FIG. 2 is a block diagram showing the configuration of an electromagnetic field simulation apparatus of the embodiment;

FIG. 3A is a schematic view illustrating a first mesh set on a calculation region, and FIG. 3B is a schematic view illustrating a second mesh set on the calculation region;

FIG. 4 is a graph showing a relationship between a size of the calculation region and a calculation time in comparison of a frequency region solution and a time region solution; and

FIGS. 5A to 5C are schematic cross-sectional views showing a method for manufacturing a semiconductor device of the embodiment.

### DETAILED DESCRIPTION

In general, according to one embodiment, a method for simulating an electromagnetic field is disclosed. The method can set a first mesh on a calculation region provided based on a medium through which an electromagnetic wave propagates. The method can calculate an electromagnetic field distribution on the first mesh by a frequency region solution based on characteristic values of the medium allocated on the first mesh. The method can set a second mesh on the calculation region. The method can allocate the electromagnetic field distribution obtained by the frequency region solution to the second mesh. In addition, the method can update the electromagnetic field distribution allocated to the second mesh in a predetermined time unit by a time region solution.

Various embodiments will be described hereinafter with reference to the accompanying drawings.

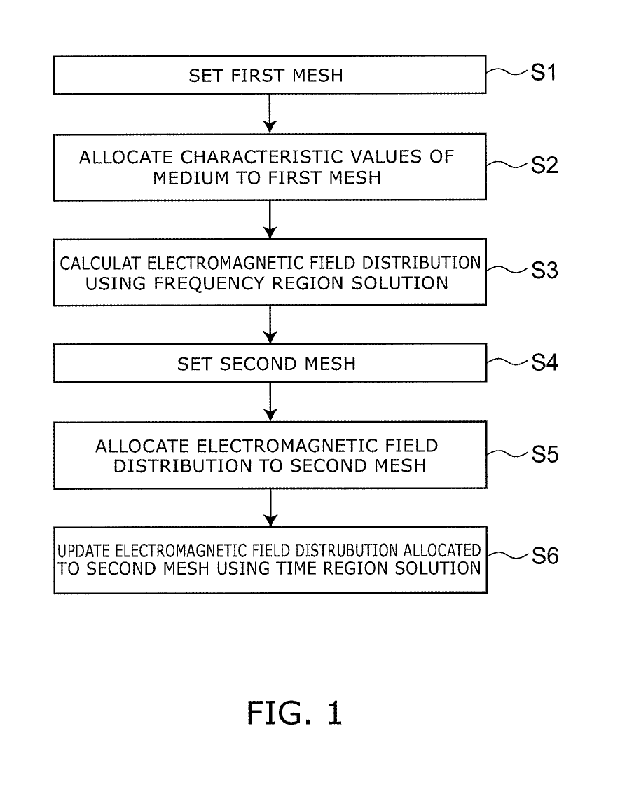

FIG. 1 is a flow chart showing a method for simulating an electromagnetic field of an embodiment.

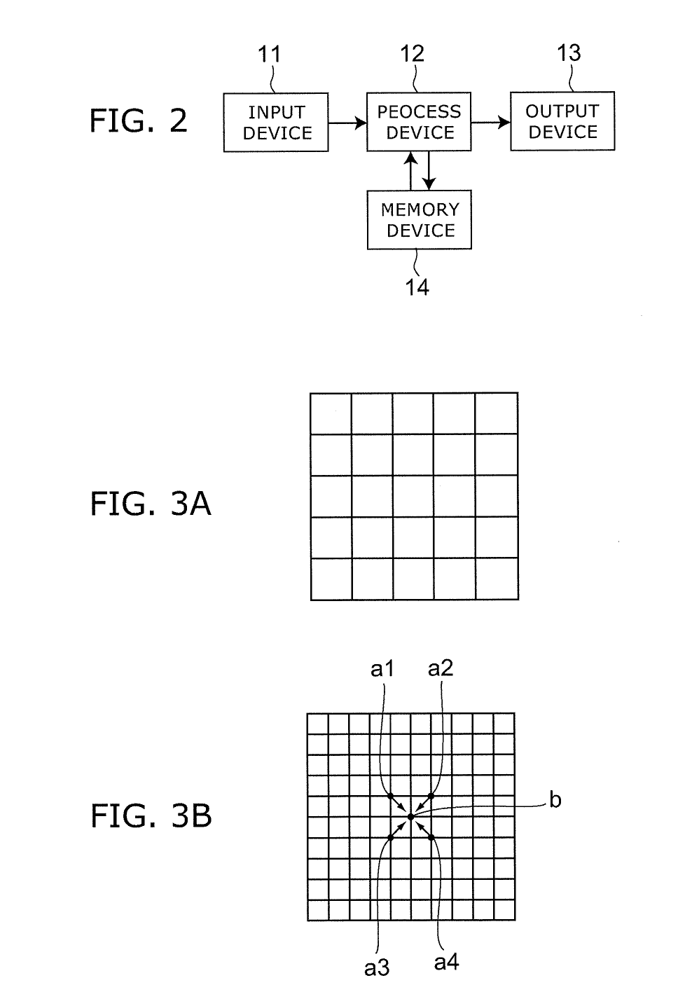

FIG. 2 is a block diagram showing the configuration of an electromagnetic field simulation apparatus of the embodiment.

As shown in FIG. 2, the electromagnetic field simulation apparatus of the embodiment includes an input device 11, a process device 12, an output device 13 and a memory device 14.

The input device 11 is a device configured to input data and a command into the memory device 12, for example, a keyboard and a mouse or the like. The memory device 14 stores a program and data necessary for the simulation. The process device 12 reads the program stored in the memory device 14 and executes the simulation described later in accordance with the program. The output device 13 outputs input results from the input device 11 and process results by the process device 12, for example, being a display and a printer.

Hereinafter, the method for simulating the electromagnetic field of the embodiment will be described. The process described below is executed by using the process device 12.

FIG. 3A shows a calculation region given or made on the basis of the analysis object medium through which the electromagnetic wave propagates. The calculation region is set as a three-dimensional space, however schematically shown in two-dimension in the figure.

Firstly, as step S1, as shown in FIG. 3A, a first mesh is set on the calculation region. That is, the calculation region (space) is divided into multiple fine meshes (cell) to be discrete.

Then, a mesh for electric field calculation and a mesh for magnetic field calculation are set separately. For example, a first mesh for the electric field calculation and a first mesh for the magnetic field calculation are set with a relative shit responding to phase difference between the electric field and the magnetic field in the electromagnetic wave.

Next, as step S2, characteristic values of the analysis object medium are defined on the first mesh. More specifically, physical property values of the medium in the mesh are allocated to every mesh. For example, when an exposure process in lithography is simulated, physical property values (dielectric constant, magnetic permeability etc.) of a light transmissive substrate, a light shield film and a halftone film or the like of a mask are used for the characteristic values of the medium.

The above physical property values of the medium are input from the input device 11. The characteristic values (frequency, wavelength, intensity, incident angle, polarization state or the like) of the light (electromagnetic wave) propagating through the medium are also input from the input device 11.

Next, as step S3, the electromagnetic field distribution (electromagnetic field for every mesh) on the first mesh is calculated using the frequency region solution on the basis of the physical property values of the medium and the characteristic values of the electromagnetic wave allocated to the above first mesh. The frequency region solution is a method by which the relation meeting a steady state of the electromagnetic wave is solved, and for example, a rigorous coupled wave analysis (RCWA) method is exemplified.

The electromagnetic distribution in the initial state immediately after incidence of the electromagnetic wave into the medium, namely, a transient state before the steady state without temporal variation is obtained is calculated by using the frequency region solution.

Next, as step S4, as shown in FIG. 3B, a second mesh is set on the calculation region. The second mesh is finer than the first mesh and the size of the second mesh is smaller than the size of the first mesh.

Next, as step S5, the electromagnetic field distribution on the first mesh obtained by the above frequency region solution is allocated to the second mesh.

The second mesh is set finer than the first mesh, and the number of meshes of the second mesh is more than the number of meshes of the first mesh. For example, the electromagnetic field distribution on the finer second mesh is calculated by interpolation from the electromagnetic field distribution on the first mesh.

The electromagnetic field distribution at point b in the second mesh can be interpolated as an averaged value of extent of contribution from the electromagnetic field distribution at every point a1 to a4 (shown in FIG. 3) in the first mesh.

Here, in the calculation by the frequency region solution, the calculation results are allocated to the frequency space mesh with higher resolution as low dimensional components, and thereby the electromagnetic field distribution in the second mesh may also be interpolated.

The electromagnetic field distribution at every mesh is not always the electromagnetic field distribution at a lattice point, and for example, may be at a center point of every mesh.

In steps from step S1 to step S5, the electromagnetic fields at every mesh in the second mesh are obtained. Also in setting the second mesh, the mesh for the electric field calculation and the mesh for the magnetic field calculation are separately set. The electric field is allocated to every mesh for the electric field calculation and the magnetic field is allocated to every mesh for the magnetic field calculation.

Next, in step S6, the electromagnetic field distribution allocated to the second mesh is updated in a predetermined micro time unit using the time region solution.

The time region solution is a method by which the state (electromagnetic field) of electromagnetic wave propagating through the analysis object medium according to time is calculated. The time region solution is, for example, a finite difference time domain (FDTD) method by which Maxwell equation is differentiated in space/time region and solved, and thereby the electromagnetic field distribution is obtained. Furthermore, the time region solution is, for example, a constrained interpolation profile (CIP) method using an advection equation.

The electromagnetic field distribution on the second mesh obtained the above step S5 is set to be the electromagnetic field distribution at a certain instant in the initial state before the electromagnetic wave is incident to the medium and the steady state is obtained, and the electromagnetic field distribution is updated from the state in a predetermined micro time unit using the time region solution. Thereby, the electromagnetic field distribution showing the steady state of the electromagnetic wave propagating through the analysis object medium can be obtained.

Also in the calculation by the time region solution, the same physical property values of the medium and the same characteristic values of the electromagnetic wave as those in the calculation by the frequency region solution in the former step are used.

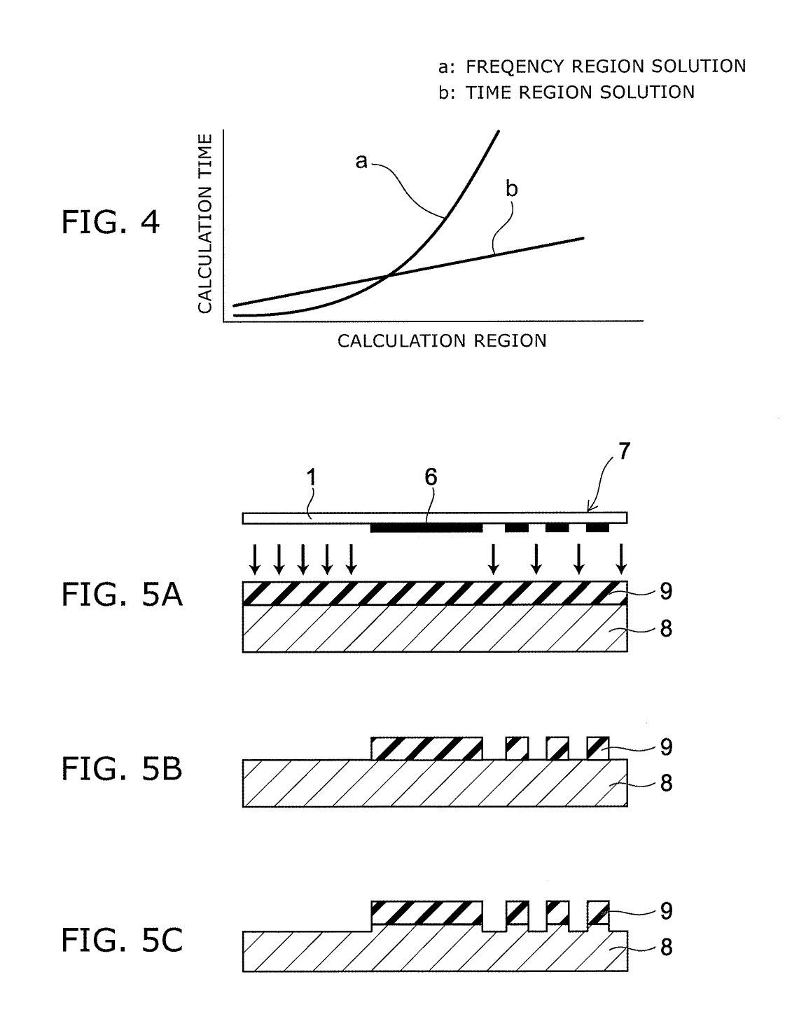

Here, FIG. 4 is a graph showing a relationship between a size of the calculation region and a calculation time in comparison of the frequency region solution and the time region solution. The horizontal axis represents the size of the calculation region and the vertical axis represents the calculation time. a represents characteristics of the frequency region solution and b represents characteristics of the time region solution.

When the size of the calculation region in the frequency region solution is small, the calculation can be performed with a higher speed than the time region solution. However, the size of the calculation region increases, that is, the number of meshes increases, the calculation time by the frequency region solution remarkably increases.

In the simulation, the calculation is performed assuming that the electromagnetic wave occurs in space without any electromagnetic wave and starts to propagate through the analysis object medium, therefore propagation state different from real phenomena may be simulated in the initial state immediately after incidence of the electromagnetic wave into the medium. For example, in the simulation, initial wave front incident to the medium breaks unnaturally, influence of the broken wave front propagates through whole of the medium and it may takes a long time to disappear the influence. Therefore, the necessity is low to update in the micro time unit the electromagnetic field distribution in the initial state immediately after the incidence of the electromagnetic wave to the medium, rather than spending unnecessary calculation time.

In the embodiment, in the initial state until the influence of the break of the above wave front converges, the electromagnetic field is not calculated according to time, and the state where the influence of the break of the above wave front converges to some extent is calculated using the time region solution. More specifically, in the initial state, it does need to calculate the electromagnetic field distribution many times every predetermined time, only one calculation by the frequency region solution is needed. This results in reduction of total calculation time without spending unnecessary time for the calculation of the initial state.

Furthermore, the first mesh to which the frequency region solution is applied is set relatively rough, and thus the number of meshes is small and the size of the calculation is small. Therefore, as shown by a graph a in FIG. 4 described above, when the frequency region solution is used on the first mesh set relatively rough in the initial state, significantly high speed calculation can be performed.

After the electromagnetic field distribution on the first mesh is calculated using the frequency region solution, the mesh and analysis method are changed over. More specifically, the mesh set on the calculation region is changed over to the finer second mesh and the electromagnetic field distribution allocated to the second mesh is updated in a predetermined micro time unit by the time region solution. This allows the steady state electromagnetic field distribution to be obtained in high precision. In the time region solution, even if the number of meshes increases, that is, the size of the calculation region increases, the calculation time does not increase as shown by a graph b in FIG. 4.

As described above, according to the embodiment, the electromagnetic field distribution in the initial state immediately after the incidence of the electromagnetic wave to the medium is calculated using the frequency region solution, after this, the electromagnetic field distribution obtained by the frequency region solution is updated in the predetermined micro time unit by the time region solution, and thus the total calculation time and the calculation cost can be reduced while maintaining the high calculation precision.

The process described above is executed in a parallel processing by using multiple process devices, and thus the calculation time can be more reduced. That is, the calculation region is divided into multiply and calculations for every divided region are executed in parallel by using the multiple process devices.

When simulating light transmitting through the medium including complex shape and propagation of reflected light by a multilayer film, it may take a long time till the steady state is obtained since the initial incidence of the light to the analysis object medium. Also in this case, according to the embodiment, it is possible to calculate the electromagnetic field distribution in the steady state in a short time.

Assuming that the mesh number in a x direction is Nₓ, the mesh number in a y direction is N_{y} and the mesh number in a z direction is N_{z} in a three dimensional space, the calculation time depends on the total mesh number (N=Nₓ×N_{y}×N_{z}).

The calculation time T_a by the frequency region solution is proportional to N³.

The calculation time T_b by the time region solution is proportional to N×Nₜ. Nt is a step number in the calculation of Nt. When convergence of the calculation is bad, for example, the shape defined in the region is extremely complicated, Nₜ is extremely large number and exerts influence on the calculation time.

Actually, an install method of program, namely improvement of diagonalization algorithm and application of parallel processing or the like based on multiple central processing units (CPU) change the relationship between the calculation speed by the two methods described above. Therefore, under consideration of speed difference due to the install, the mesh number is decided on the basis of the relationship described above.

The simulation method of the embodiment can be utilized for calculation of, for example, diffraction of transmitted light based on a mask shape in a lithography field and imaging characteristics based on a topography shape on a substrate.

FIGS. 5A to 5C show a method for manufacturing a semiconductor device as one example based on the simulation method of the embodiment.

First, the simulation described above is performed using the analysis object medium as a mask 7. As a result, the electromagnetic field distribution in the steady state obtained by the time region solution on the second mesh is obtained. That is, the electromagnetic field distribution at a time when the steady state is obtained by transmission of the exposed light through the mask 7 is obtained.

On the basis of the result, lithography conditions are set. The lithography conditions are, for example, mask design values (mask size, mask shape, pattern size, pattern shape, pattern layout and the like), exposure conditions (wavelength of exposure light, incidence angle, other optical characteristics and the like).

Next, a pattern latent image is transferred to a resist 9 formed on a semiconductor wafer 8 on the basis of the above lithography conditions. The semiconductor wafer 8 includes, for example, the substrate and films to be processed (insulating film, semiconductor film, metal film and the like) formed on the substrate.

Specifically, as shown in FIG. 5A, exposure is performed to the resist 9 using the mask 7. The mask 7 has a structure such that a light shield film (or half tone film) 6 is formed on a substrate 1 (for example, quartz) having permeability to the exposure light. This exposure transfers the pattern latent image corresponding to the pattern formed on the mask 7 to the resist 9. After the exposure, development is performed to remove selectively the resist. This causes the resist 9 to be patterned as shown in FIG. 5B.

Next, processes such as etching and impurity introduction to the semiconductor wafer 8 and the like are performed using the patterned resist 9 as a mask. This provides the semiconductor device having the pattern corresponding to the pattern formed on the photomask 7 formed.

Moreover, the simulation method of the embodiment can also be illustratively applied to calculation of reflection state in a reflection type mask in lithography based on Extreme Ultra Violet (EUV) light or the like. In addition, the method for simulating according to the embodiment can also be applied to other fields other than semiconductor process, for example, analyses of the electromagnetic field of an antenna for wireless telecommunications, a photosensor and devices such as a photonic crystal with a fine structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A method for simulating an electromagnetic field comprising:
setting a first mesh on a calculation region provided based on a medium through which an electromagnetic wave propagates;
calculating an electromagnetic field distribution on the first mesh by a frequency region solution based on characteristic values of the medium allocated on the first mesh;
setting a second mesh on the calculation region;
allocating the electromagnetic field distribution obtained by the frequency region solution to the second mesh; and
updating the electromagnetic field distribution allocated to the second mesh in a predetermined time unit by a time region solution.

2. The method according to claim 1, wherein the first mesh is rougher than the second mesh.

3. The method according to claim 2, wherein the electromagnetic field distribution on the second mesh is calculated by interpolation from the electromagnetic field distribution on the first mesh.

4. The method according to claim 1, wherein an electromagnetic field distribution in an initial state immediately after incidence of the electromagnetic wave to the medium is calculated using the frequency region solution.

5. The method according to claim 1, wherein each of the first mesh and the second mesh includes a mesh for electric field calculation and a mesh for magnetic field calculation.

6. The method according to claim 5, wherein the mesh for the electric field calculation and the mesh for the magnetic field calculation are set with a relative [symbol] responding to phase difference between the electric field and the magnetic field in the electromagnetic wave.

7. A electromagnetic field simulation apparatus comprising:
an input device configured to input characteristic values of a medium through which an electromagnetic wave propagates; and
an process device configured to perform processing of setting a first mesh on a calculation region provided based on the medium, processing of calculating an electromagnetic field distribution on the first mesh using a frequency region solution based on the characteristic values of the medium allocated on the first mesh, processing of setting a second mesh on the calculation region and processing of updating the electromagnetic field distribution allocated to the second mesh in a predetermined time unit using a time region solution.

8. The apparatus according to claim 7, wherein the first mesh is rougher than the second mesh.

9. The apparatus according to claim 8, wherein the process device is configured to calculate the electromagnetic field distribution on the second mesh by interpolation from the electromagnetic field distribution on the first mesh.

10. The apparatus according to claim 7, wherein the process device is configured to calculate an electromagnetic field distribution in an initial state immediately after incidence of the electromagnetic wave to the medium using the frequency region solution.

11. The apparatus according to claim 7, wherein each of the first mesh and the second mesh includes a mesh for electric field calculation and a mesh for magnetic field calculation.

12. The apparatus according to claim 11, wherein the mesh for the electric field calculation and the mesh for the magnetic field calculation are set with a relative [symbol] responding to phase difference between the electric field and the magnetic field in the electromagnetic wave.

13. A method for manufacturing a semiconductor device comprising:
setting a first mesh on a calculation region provided based on a medium through which an electromagnetic wave propagates;
calculating an electromagnetic field distribution on the first mesh using a frequency region solution based on characteristic values of the medium allocated on the first mesh;
setting a second mesh on the calculation region;
allocating the electromagnetic field distribution obtained by the frequency region solution to the second mesh;
updating the electromagnetic field distribution allocated to the second mesh in a predetermined time unit by a time region solution;
setting lithography conditions based on the electromagnetic field distribution obtained by the time region solution;
transferring a pattern latent image to a resist formed on a semiconductor wafer based on the lithography conditions;
patterning the resist by developing the resist having the pattern latent image transferred; and
processing the semiconductor wafer using the patterned resist as a mask.

14. The method according to claim 13, wherein the first mesh is rougher than the second mesh.

15. The method according to claim 14, wherein the electromagnetic field distribution on the second mesh is calculated by interpolation from the electromagnetic field distribution on the first mesh.

16. The method according to claim 13, wherein an electromagnetic field distribution in an initial state immediately after incidence of the electromagnetic wave to the medium is calculated using the frequency region solution.

17. The method according to claim 13, wherein each of the first mesh and the second mesh includes a mesh for electric field calculation and a mesh for magnetic field calculation.

18. The method according to claim 17, wherein the mesh for the electric field calculation and the mesh for the magnetic field calculation are set with a relative [symbol] responding to phase difference between the electric field and the magnetic field in the electromagnetic wave.

19. The method according to claim 13, wherein the medium is an exposure mask to the resist.
